(19) United States
(12) Patent Application Publication
(10) Pub. No.: US 2008/0096083 A1
(43) Pub. Date: Apr. 24, 2008

(54) ASSEMBLY STRUCTRE FOR FUEL CELL STACKS AND FAN

(76) Inventors: YEAN-DER KUAN, Taipei (TW); Chien-An Chen, Taipei (TW); Wen Sui Chuang, Taipei (TW)

Correspondence Address: G. LINK CO., LTD, 3550 BELL ROAD, MINOOKA, IL, 60447, US

(21) Appl. No.: 11/874,081

(22) Filed: Oct. 17, 2007

(30) Foreign Application Priority Data
Oct. 18, 2006 (TW) 095218361

(51) Int. Cl. H01M 8/02

(52) U.S. Cl. 429/34

(57) ABSTRACT

This invention discloses an assembly structure for the fuel cell stack and the fan, which comprises at least one or two fuel cell stack(s) and a fan. Each fuel cell stack includes more than one air inlets and more than one air outlets. The fan includes at least one shaft and more than one fan blades, the fan blades being combined with said shaft and in rotation accompanying with the rotation of said shaft, and said fan being associated with said air outlets of said fuel cell stack(s). The axial direction of said shaft faces toward said air outlets of said fuel cell stack(s).

### FIELD OF THE INVENTION

This invention relates to an assembly structure for assembling the fuel cell stack(s) and the fan together, more particularly to an assembly structure for assembling at least one or two fuel cell stack(s) and a fan together.

### BACKGROUND OF THE INVENTION

In the US Patent Publication No. 20050026027, a fuel cell system entitled ‘FUEL CELL SYSTEM’ is disclosed, in which a fan is provided for the generation of air flow in order to enable the cathode of the fuel cell to obtain the supply of oxygen gas (e.g. air) easily. Inasmuch as the fan structure disclosed in US 20050026027 can generate merely linear type air flow direction, a plurality of fuel cells can only be positioned in the same side of the fan. In the case a fuel cell system with a large number of fuel cells is needed, the total height of those fuel cells in the vertical direction becomes large. Thus, a slim type appearance of the fuel cell system is not easily obtained.

In order to improve the above drawback of the conventional fuel cell system, the applicant of this invention proposes an assembly structure for the fuel cell stack(s) and the fan, in which one or two fuel cell stack(s) and a fan are assembled together, so as to improve extremely the drawback of the enlargement of total height of fuel cell system in the vertical direction.

### SUMMARY OF INVENTION

The main object of this invention is to provide an assembly structure for the fuel cell stack(s) and the fan, in which only one fan is used for the achievement of the above purpose in the assembly of one or two fuel cell stack(s) and the fan together, and the drawback of the enlargement of total height of conventional fuel cell system in the vertical direction due to the increase of the numbers of fuel cell stacks is extremely improved.

This invention provides an assembly structure for fuel cell stack and fan, which comprises one or two fuel cell stack(s) and a fan. Each fuel cell stack includes more than one air inlets and more than one air outlets. The fan includes a shaft and more than one fan blades, The fan blades are combined with the shaft and in rotation accompanying with the rotation of the shaft, and the fan is associated with the air outlets of the fuel cell stack(s). The axial direction of said shaft faces toward the air outlets of the fuel cell stacks.

### BRIEF DESCRIPTION OF DRAWINGS

The structure, features and effectiveness of this invention will be further understood by the following description of the preferred embodiments of this invention in conjunction with the accompanied drawings, wherein:

FIG. 1 is a three dimensional exploded view showing the first embodiment of the assembly structure for fuel cell stack(s) and fan of this invention;

FIG. 2 is a three dimensional view of FIG. 1;

FIG. 3 is a three dimensional exploded view showing the second embodiment of the assembly structure for the fuel cell stack(s) and the fan of this invention; and

FIG. 4 is a three dimensional view of FIG. 3.

### DETAILED DESCRIPTION OF THE INVENTION

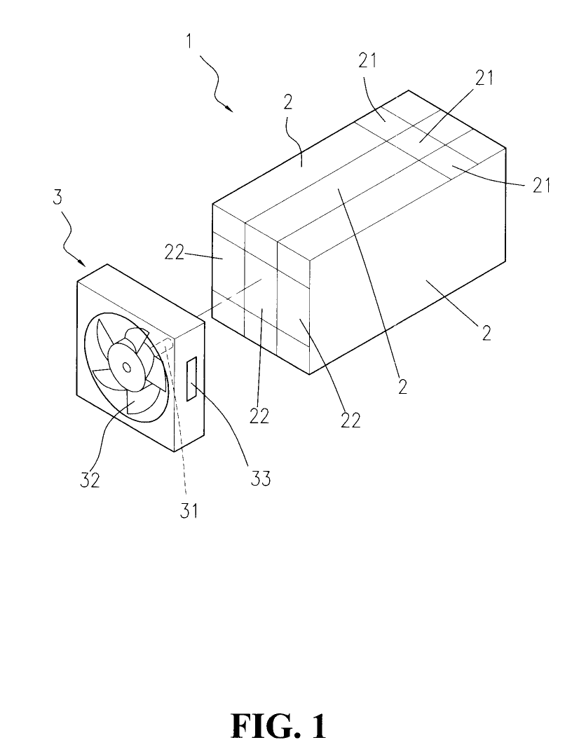

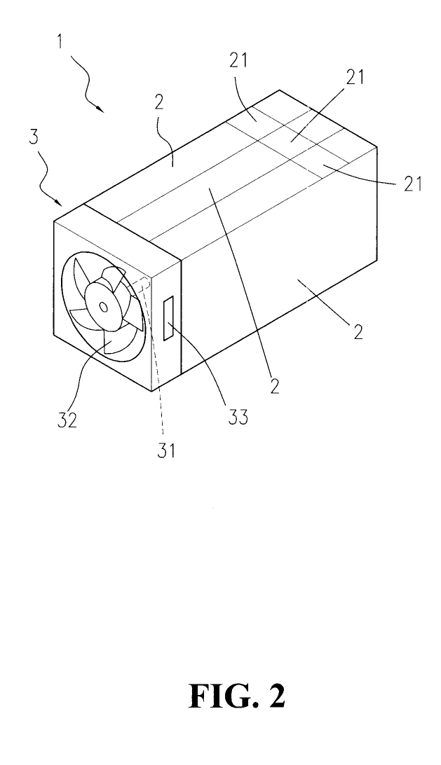

FIG. 1 is a three dimensional exploded view showing the first embodiment of the assembly structure for fuel cell stack(s) and fan of this invention. FIG. 2 is a three dimensional view of FIG. 1. In the first embodiment, the assembly structure for fuel cell stack(s) and fan of this invention is mainly composed of a fuel cell stack 1 and a fan 3, which will be described in details as below.

The fuel cell stack 1 is formed by the stack of more than one fuel cells 2, each fuel cell 2 being provided with air inlet 21 and air outlet 22. The ambient air flows from the air inlet 21 to the inside, then to the cathode of the membrane electrode assembly of the fuel cell 2, and finally the product at the cathode and the residual air is exhausted from the air outlet 22 to the outside. The fuel cell stack 1 of this invention can use conventional fuel cell stack, such as the fuel cell stack formed by the stack of direct methanol fuel cells.

The fan 3 comprises a shaft 31 and more than one fan blades 32, and the fan blades 32 is combined with the shaft 31. The shaft 31 is rotated by the rotation of the motor (not shown) of the fan 3, in turn, the fan blade 32 are rotated by the rotation of the shaft 31. The fan 3 is provided at the air outlet 22 of the fuel cell stack 1, and the fan 3 is positioned in such manner that the axial direction of the shaft 31 faces toward the air outlet 22 of the fuel cell stack 1.

After the fan 3 is started, the fan blades 32 is rotated accompanying with the rotation of the shaft 31 so that the air is driven out. In operation, the fan 3 brings the air intake from the air inlets 21. Due to the momentum of the air flow, the air stream flows to the cathode of the membrane electrode assembly of the fuel cell 2. Finally, the products at the cathode and the residual air are exhausted from the air outlet 22 and reaches the fan 3. Because the air flow can be changed from axial direction to radial direction by the structure of the fan 3 of this invention, the products of the cathode at the air outlet 22 and the residual air can be exhausted through the air exhaust grille 33 thereby.

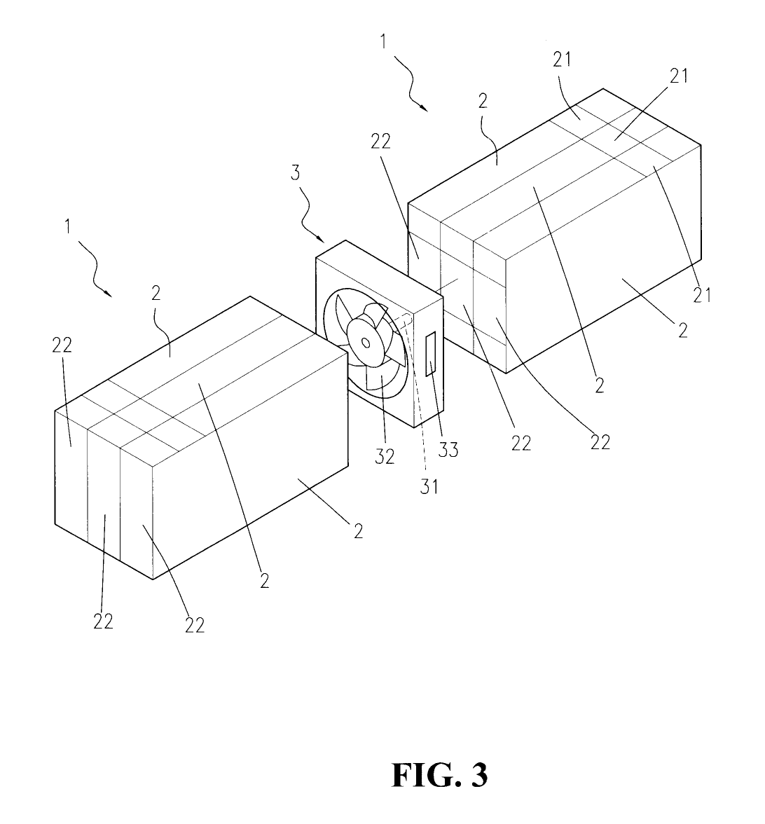

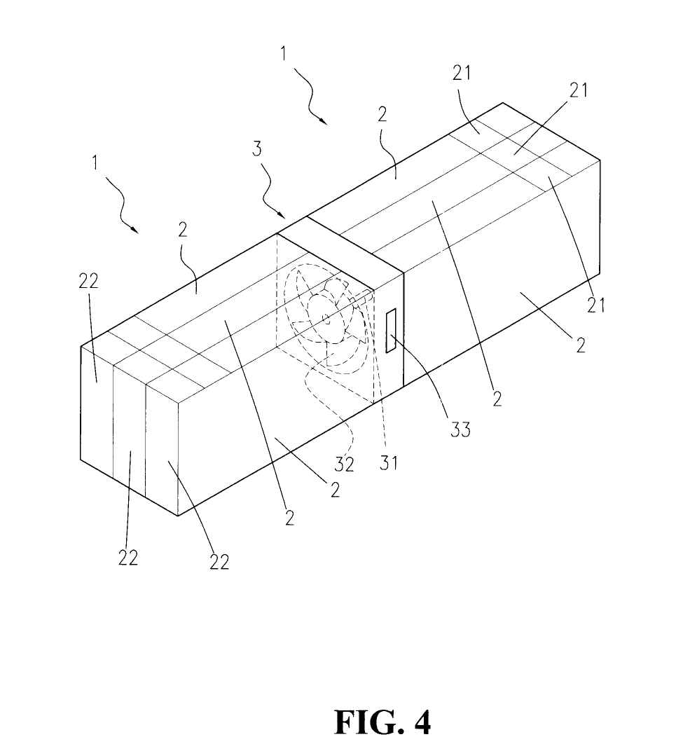

FIG. 3 is a three dimensional exploded view of the second embodiment of the assembly structure for fuel cell stack(s) and fan of this invention. FIG. 4 is the three dimensional view of FIG. 3. In the second embodiment, the assembly structure for fuel cell stack(s) and fan of this invention is mainly composed of 2 fuel cell stacks 1 and a fan 3. The fuel cell stack 1 and the fan 3 used in the second embodiment are the same as those in the first embodiment.

In the second embodiment, the fuel cell stacks 1 are provided in both end directions of the shaft 31, in other words, on the opposite two side surfaces of the fan 3 respectively.

The air flow pattern within two fuel cell stacks 1 in the second embodiment is the same as that in the first embodiment, therefore, the description being omitted thereby.

By the combination of fan with one or two fuel cell stack(s) of this invention, not only excellent air stream flow effectiveness can be obtained for each fuel cell stack, but also the drawback of the enlargement of total height of conventional fuel cell system in the vertical direction due to the increase of the numbers of fuel cell stacks is extremely improve. These are the advantages and useful effectiveness of the present invention.

While this invention has been described in details by the preferred embodiments, however, which are for illustrative purpose only, and the scope of this invention is not limited by those preferred embodiment. The modifications and variations conducted by any person skilled in the art after referring to the above disclosure should be considered within the scope of this invention, if they are not departing from the spirit and scope of the present invention.

What is claimed is:

1. A assembly structure for the fuel cell stack and the fan, comprising:
one or two fuel cell stack(s), each fuel cell stack including more than one air inlet and more than one air outlet;
a fan, including a shaft and more than one fan blades, said fan blades being combined with said shaft and in rotation accompanying with the rotation of said shaft, and said fan being combined with said air outlets of said fuel cell stack(s);
wherein the axial direction of said shaft faces toward said air outlets, and wherein said fan blades being used to change the air flow from said axial direction to the radial direction.

2. The assembly structure for the fuel cell stack and the fan as claimed in claim 1, wherein said fuel cell stack(s) is a direct methanol fuel cell stack(s).

3. The assembly structure for the fuel cell stack and the fan as claimed in claim 1, wherein said fan is associated said air outlets of two fuel cell stacks, and both ends of said shaft in the axial direction face said air outlets of said two fuel cell stacks respectively.
